(19) United States
(12) Patent Application Publication
(10) Pub. No.: US 2015/0152916 A1
(43) Pub. Date: Jun. 4, 2015

(54) ROTATING DEVICE

(71) Applicant: Samsung Electro-Mechanics Japan Advanced Technology Co., Ltd., Shizuoka (JP)

(72) Inventor: Ryusuke SUGIKI, Shizuoka (JP)

(21) Appl. No.: 14/548,407

(22) Filed: Nov. 20, 2014

(30) Foreign Application Priority Data
Nov. 29, 2013 (JP) 2013-247362

(51) Int. Cl. F16C 33/10; F16C 17/04

(52) U.S. Cl. CPC F16C 33/107; F16C 17/045

(57) ABSTRACT

A rotating device includes a beam unit and a beam receiving unit. The beam unit includes a shaft part, a first flange part projecting in a ring shape from one end of the shaft part in a radial direction, and a second flange part projecting in a ring shape in the radial direction from another end of the shaft part. The beam receiving unit includes a sleeve part surrounding the shaft part in a state in which the sleeve part is rotatable, wherein a lubricant is provided in a region including a gap between the beam unit and the beam receiving unit. A radial dynamic pressure generating groove is provided between the beam unit and the sleeve part, and first and second thrust dynamic pressure generating grooves are provided between the first flange part and the sleeve part, and between the second flange part and the sleeve part, respectively.

### CROSS-REFERENCE TO RELATED APPLICATIONS

This application is based upon and claims the benefit of priority of Japanese Patent Application No. 2013-247362 filed on Nov. 29, 2013, the entire contents of which are incorporated herein by reference.

### BACKGROUND OF THE INVENTION

1. Field of the Invention

The present invention relates to a rotating device.

2. Description of the Related Art

A disk drive unit, such as an HDD (Hard Disk Drive), for example, is one type of rotating device. In the disk drive unit, a recording disk is set on a rotor part which is rotatably supported by a stator part, for example, and the recording disk rotates together with the rotor part. In such a disk drive unit, when a rotational axis of the rotor part tilts during rotation due to external shock applied to the disk drive unit, the rotation of the recording disk becomes unstable and a data read and/or write error may occur.

A configuration that enables stable rotation of the rotor part around its rotational axis has been proposed. According to this proposed configuration, radial dynamic pressure generating grooves that generate dynamic pressure in a lubricant are provided with a separation in an axial direction of the rotational axis within a gap in which the stator part and the rotor part oppose each other in a radial direction that is perpendicular to the rotational axis.

Applicant is aware of related art proposed in Japanese Laid-Open Patent Publications No. 2013-2524 and No. 2006-64171, for example.

The reduction in size and thickness and the increase in storage capacity of the disk drive unit described above have enabled the disk drive unit to be provided not only in desk-top personal computers, but also in various electronic apparatuses including lap-top personal computers, or the like. In addition, due to popular use of portable apparatuses such as tablet PCs (Personal Computers) or the like, for example, there are demands to further reduce the size and thickness of the disk drive unit.

However, when the thickness of the disk drive unit is reduced, the stator part and the rotor part also need to be reduced, and it becomes difficult to provide the radial dynamic pressure generating grooves in the axial direction in a sufficiently large region within the gap between the stator part and the rotor part. For this reason, the rotation of the rotor part easily becomes unstable due to effects of external shock or the like applied to the disk drive unit, and there is a possibility of frequently generating the data read and/or write error of the recording disk that is set on the rotor part.

### SUMMARY OF THE INVENTION

Embodiments of the present invention may provide a rotating device that can maintain stable rotation of a rotor part in a thinned configuration.

According to one aspect of the present invention, a rotating device may include a beam unit that includes a shaft part, a first flange part projecting in a ring shape from one end of the shaft part in a radial direction perpendicular to an axial direction, and a second flange part projecting in a ring shape in the radial direction from another end of the shaft part; a beam receiving unit that includes a sleeve part surrounding the shaft part in a state in which the sleeve part is rotatable relative to the shaft part, wherein a lubricant is provided in a region that includes a first gap between the beam unit and the beam receiving unit; a single radial dynamic pressure generating groove provided at one of mutually opposing surfaces of the shaft part and the sleeve part, opposing each other in the radial direction; a first thrust dynamic pressure generating groove provided at one of mutually opposing surfaces of the first flange part and the sleeve part, opposing each other in the axial direction; and a second thrust dynamic pressure generating groove provided at one of mutually opposing surfaces of the second flange part and the sleeve part, opposing each other in the axial direction, wherein the first thrust dynamic pressure generating groove and the second thrust dynamic pressure generating groove are separated from the shaft part along the radial direction.

According to another aspect of the present invention, a rotating device may include a beam unit that includes a shaft part, a first flange part projecting in a ring shape from one end of the shaft part in a radial direction perpendicular to an axial direction, and a second flange part projecting in a ring shape in the radial direction from another end of the shaft part; a beam receiving unit that includes a sleeve part surrounding the shaft part in a state in which the sleeve part is rotatable relative to the shaft part, wherein a lubricant is provided in a region that includes a first gap between the beam unit and the beam receiving unit; a single radial dynamic pressure generating groove provided at one of mutually opposing surfaces of the shaft part and the sleeve part, opposing each other in the radial direction; a first thrust dynamic pressure generating groove provided at one of mutually opposing surfaces of the first flange part and the sleeve part, opposing each other in the axial direction; and a second thrust dynamic pressure generating groove provided at one of mutually opposing surfaces of the second flange part and the sleeve part, opposing each other in the axial direction, wherein the first thrust dynamic pressure generating groove and the second thrust dynamic pressure generating groove are separated from the shaft part along the radial direction, and wherein widths along the radial direction of the first thrust dynamic pressure generating groove and the second thrust dynamic pressure generating groove are smaller than a width along the axial direction of the single radial dynamic pressure generating groove.

According to still another aspect of the present invention, a rotating device may include a beam unit that includes a shaft part, a first flange part projecting in a ring shape from one end of the shaft part in a radial direction perpendicular to an axial direction, and a second flange part projecting in a ring shape in the radial direction from another end of the shaft part; a beam receiving unit that includes a disk-shaped part surrounding the shaft part in a state in which the disk-shaped part is rotatable relative to the shaft part, wherein a lubricant is provided in a region that includes a first gap between the beam unit and the beam receiving unit; a radial dynamic pressure generating groove provided at one of mutually opposing surfaces of the beam unit and the disk-shaped part, opposing each other in the radial direction; a first thrust dynamic pressure generating groove provided at one of mutually opposing surfaces of the first flange part and the disk-shaped part, opposing each other in the axial direction; and a second thrust dynamic pressure generating groove provided at one of mutually opposing surfaces of the second flange part and the disk-shaped part, opposing each other in the axial direction, wherein a dimension of the rotating device along the axial direction, at a center axis of the shaft part, is 4.0 mm or less, and wherein a thickness of the disk-shaped part along the axial direction is smaller than a length of a part of the disk-shaped part opposing the first flange part, along the radial direction.

Other objects and further features of the present invention may be apparent from the following detailed description when read in conjunction with the accompanying drawings.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIGS. 1A, 1B, and 1C are diagrams schematically illustrating an example of a general configuration of a rotating device in a first embodiment;

FIG. 2 is a cross sectional view schematically illustrating an example of the rotating device in the first embodiment;

FIG. 3 is a cross sectional view, on an enlarged scale, schematically illustrating the rotating device in the first embodiment;

FIG. 4 is a cross sectional view schematically illustrating an example of the rotating device in a second embodiment;

FIG. 5 is a cross sectional view schematically illustrating another example of the rotating device in the second embodiment; and

FIG. 6 is a cross sectional view schematically illustrating still another example of the configuration of the rotating device in the second embodiment.

### DESCRIPTION OF THE PREFERRED EMBODIMENTS

In each of the figures described hereunder, those elements and parts that are the same or substantially the same are designated by the same reference numerals, and a description thereof will not be repeated where appropriate. In addition, dimensions of the parts in each of the figures are enlarged or reduced, where appropriate, in order to facilitate understanding of the parts. Further, in each of the figures, illustration of some of the parts that may be considered unimportant in describing embodiments is omitted for the sake of convenience.

In the following description, a rotating device in one embodiment can be mounted with a recording disk that magnetically records data, and may be used as an HDD or the like.

### First Embodiment

### Configuration of Rotating Device

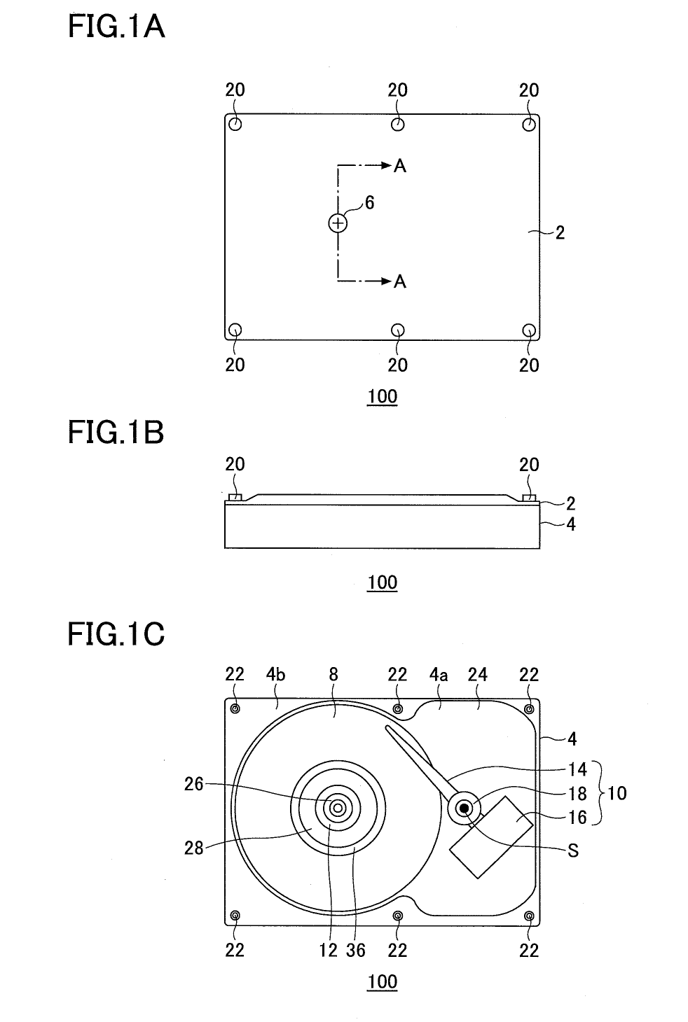

A description will be given of a rotating device 100, which is one type of a rotating device, in a first embodiment of the present invention, by referring to FIGS. 1A, 1B, and 1C. FIGS. 1A, 1B, and 10 are diagrams schematically illustrating an example of a general configuration of the rotating device in the first embodiment. FIG. 1A illustrates a plan view of the rotating device 100, FIG. 1B illustrates a side view of the rotating device 100, and FIG. 10 illustrates a plan view of the rotating device 100 in a state in which a top cover 2 thereof is removed.

The rotating device 100 includes a top cover 2, a base 4, a recording disk 8, a data read and/or write unit (hereinafter simply referred to as “data read/write unit”) 10, a cap 12, a shaft 26, a hub 28, and a clamper 36.

In the following description, in a state in which the top cover 2 is mounted on the base 4, the side of the top cover 2 is referred to as an “upper side”, and the side of the base 4 is referred to as a “lower side”. In addition, a direction parallel to a rotational axis of the recording disk 8 is referred to as an “axial direction”, and an arbitrary direction passing through the rotational axis on a plane perpendicular to the rotational axis is referred to as a “radial direction”. Further, the side further away from the rotational axis along the radial direction is referred to as an “outer peripheral side”, and the side closer to the rotational axis along the radial direction is referred to as an “inner peripheral side”. These sides and directions do not limit an orientation of the rotating device 100 in use, and the rotating device 100 may be used in an arbitrary orientation.

(Top Cover) The top cover 2 is formed by pressing an aluminum plate or a steel plate, for example. The top cover 2 may be subjected to a surface treatment such as plating or the like, for example, in order to prevent corrosion.

The top cover 2 is fixed on an upper surface of the base 4 by screws 20 located in a periphery of the top cover 2. The top cover 2 and the base 4 are fixed so as to seal the inside of the rotating device 100. A fixing screw 6 inserted through a center of the top cover 2 is screwed into a fixing screw hole of the shaft 26 that is fixed on the base 4.

(Base)

The base 4 includes a bottom surface 4a forming a bottom part of the rotating device 100, and an outer peripheral wall 4b that is formed along an outer periphery of the bottom surface 4a to surround a setting region in which the recording disk 8 is set. Screw holes 22 are provided in an upper surface of the outer peripheral wall 4b, and the screws 20 are screwed into the screw holes 22.

The top cover 2 is fixed on the upper surface of the outer peripheral wall 4b of the base 4 by the screws 20. A disk accommodating space 24 surrounded by the bottom surface 4a and the outer peripheral wall 4b of the base 4 and the top cover 2 is sealed and isolated from external environment, and is filled with clean air that is removed of dust or the like. Accordingly, adhesion of foreign particles such as dust or the like onto the recording disk 8 can be suppressed, and the possibility of a malfunction caused by the foreign particles occurring in the rotating device 100 can be reduced.

The base 4 is formed by die casting using an aluminum alloy, or pressing a metal plate using stainless steel, aluminum, or the like, for example. In the case of pressing, embossing may be performed to form projections on the upper side of the base 4. By performing embossing at predetermined parts of the base 4, deformation of the base 4 can be suppressed.

In addition, the base 4 may have a surface treated layer, such as a plated layer made of a metal material such as nickel, chromium, or the like, or a coated layer made of a resin material such as epoxy resin or the like. By providing such a surface treated layer, surface peeling of the base 4 can be prevented. Moreover, even when the recording disk 8 or the like makes contact with the surface of the base 4 during a manufacturing process, for example, the possibility of damaging the surface of the base 4, the recording disk 8, or the like can be reduced. Furthermore, compared to the coated layer made of the resin material, the plated layer made of the metal material can increase the surface hardness of the base 4 and also reduce the coefficient of friction, and thus, the possibility of damaging the surface of the base 4, the recording disk 8, or the like upon contact can further be reduced.

(Data Read/Write Unit)

The data read/write unit 10 includes a recording and reproducing head (not illustrated), a swing arm 14, a voice coil motor 16, and a pivot assembly 18. The recording and reproducing head is mounted on a tip end part of the swing arm 14, and is configured to record data on the recording disk 8, and to read data from the recording disk 8. The pivot assembly 18 pivotally supports the swing arm 14 to freely swing about a head rotational axis S as its center of swing. The voice coil motor 16 swings the swing arm 14 about the head rotational axis S as its center of swing, and moves the recording and reproducing head to a desired position on the surface of the recording disk 8. The voice coil motor 16 and the pivot assembly 18 may be formed using a known technique to control the position of the recording and reproducing head.

(Recording Disk)

The recording disk 8 may be formed by a 2.5-inch recording disk made of glass having a diameter of 65 mm, a thickness of 0.65 mm, and a center hole having diameter of 20 mm. In the rotating device 100 in this embodiment, one recording disk 8 is mounted on an outer periphery of the hub 28.

<Configuration of Bearing Mechanism>

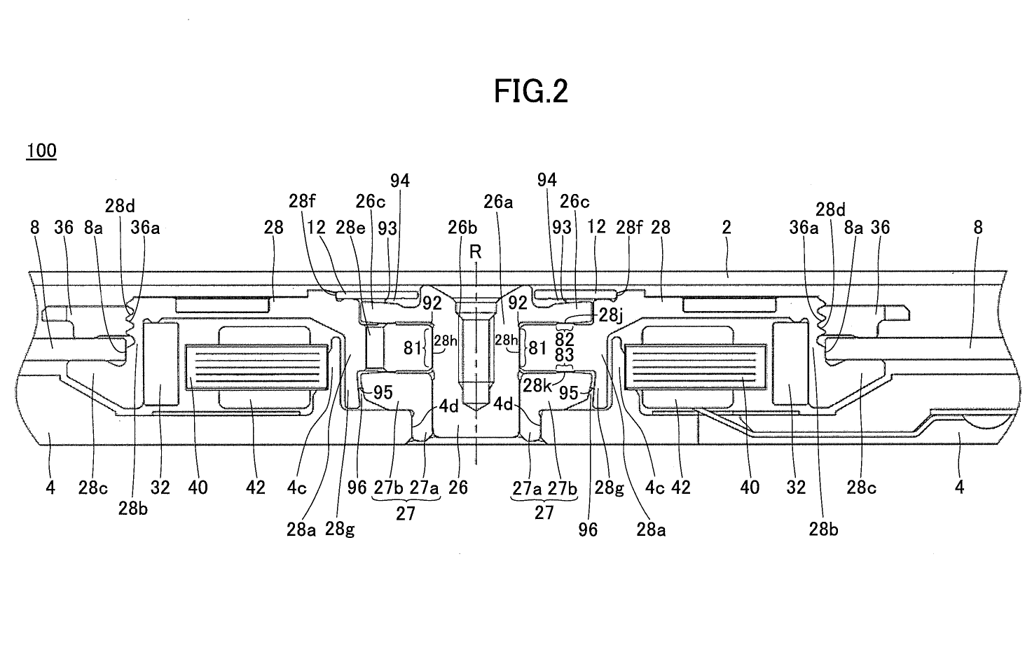

FIG. 2 is a cross sectional view schematically illustrating a cross section along a line A-A in FIG. 1A. FIG. 2 illustrates an example of a bearing mechanism of the rotating device 100 in this embodiment.

The rotating device 100 includes a stationary body (hereinafter also referred to as a “stator part”) and a rotating body (hereinafter also referred to as a “rotor part”). The stator part includes the base 4, the shaft 26, a support member 27, a stator core 40, and a coil 42. On the other hand, the rotor part includes the cap 12, the hub 28, a cylindrical magnet 32, and the clamper 36.

In the rotating device 100, a lubricant 92 fills a gap between the hub 28 and the cap 12, and a gap between the shaft 26 and the support member 27. The rotor part including the hub 28 mounted with the recording disk 8 is supported by the stator part including the shaft 26 to freely rotate.

(Hub)

The hub 28 may be made of a soft magnetic steel material such as SUS430F, for example. The hub 28 may be formed into the approximate cup-shape by subjecting the steel material to cutting, pressing, or the like, for example. A surface of the hub 28 may be subjected to a surface treatment, such as electroless nickel plating, in order to suppress peeling of residual particles adhered on the surface that is treated. The hub 28 in this embodiment is formed from a single member, however, the hub 28 may be formed from a plurality of separate members.

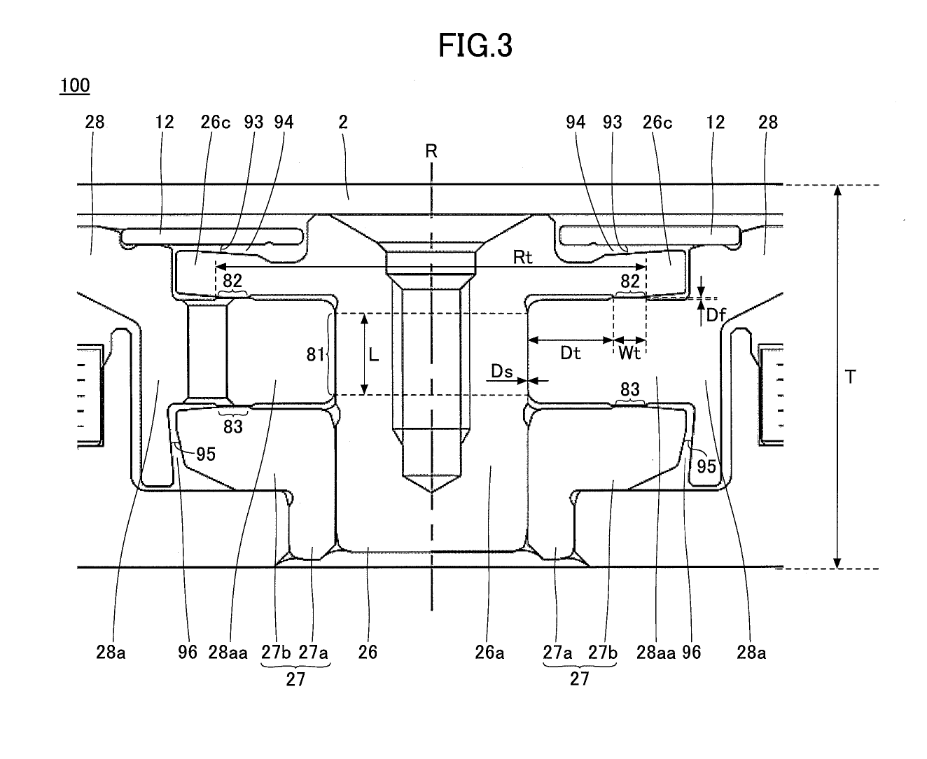

The hub 28 includes a sleeve part 28a, a fitting part 28b that fits into a center hole 8a of the recording disk 8, and a setting part 28c having an upper surface on which the recording disk 8 is set. As illustrated in FIG. 3 which will be described later, the sleeve part 28a has a disk-shaped part 28aa which surrounds a shaft part 26a of the shaft 26. The hub 28 also includes male screw grooves 28d that are formed on an outer peripheral surface of the fitting part 28b and engages the clamper 36, and a communication passage 28e communicating between the upper surface side and the lower surface side of the sleeve part 28a. The communication passage 28e stabilizes the rotation of the hub 28, by reducing a pressure difference applied to the lubricant 92 in a region in which the lubricant 92 is provided.

The recording disk 8 is fixed on the hub 28 in a state in which the fitting part 28b of the hub 28 fits into the center hole 8a and the recording disk 8 is sandwiched between the clamper 36 and the setting part 28c. The recording disk 8, fixed on the hub 28 in this manner, rotates together with the hub 28.

(Clamper)

The clamper 36 includes a screw hole 36a defined by an inner peripheral surface having female screw grooves that engage the male screw grooves 28d formed on the outer peripheral surface of the fitting part 28b of the hub 28. The clamper 36 may be made of a steel material such as stainless steel SUS303, for example, by subjecting the steel material to cutting or the like. The clamper 36 is screwed onto the fitting part 28b of the hub 28 so that a lower surface of the clamper 36 makes contact with an upper surface of the recording disk 8, and fixes the recording disk 8 on the setting part 28c of the hub 28.

(Cylindrical Magnet)

The cylindrical magnet 32 is fixed to an inner peripheral surface of the fitting part 28b of the hub 28 by an adhesive, for example. The cylindrical magnet 32 may be made from a ferrite magnetic material, a rare earth magnetic material, or the like, for example, and may include a binder made of a resin such as polyamide. In addition, the cylindrical magnet 32 may have a stacked structure formed by a ferrite magnetic layer and a rare earth magnetic layer.

The cylindrical magnet 32 is magnetized to have twelve (12) poles, for example, along a circumferential direction of an inner peripheral surface thereof, and opposes an outer peripheral surface of the salient poles provided on the stator core 40 via a gap in the radial direction.

(Stator Core)

The stator core 40 includes a ring-shaped part, and nine (9) salient poles extending from the ring-shaped part on the outer peripheral side. The stator core 40 is fixed by being press-fit or loosely fitted on an outer peripheral surface of a projecting part 4e that projects in a cylindrical shape from the bottom surface of the base 4. The stator core 40 is formed by stacking six (6) thin electromagnetic steel plates each having a thickness of 0.2 mm, for example, into a single plate member by caulking, for example. The surface of the stator core 40 is subjected to an insulator coating, such as electro-coating, powder coating, or the like. The coil 42 is wound on each salient pole of the stator core 40. A driving magnetic flux is generated along the salient poles when a 3-phase driving current having an approximately sinusoidal waveform flows to the coil 42. The stator core 40 may be a solid core formed by solidifying magnetic powder such as sintered compact.

(Shaft)

The shaft 26 includes the shaft part 26a, a fixing screw hole 26b provided in the shaft part 26a along a rotational axis R, and a first flange part 26c projecting from an upper end part of the shaft part 26a in a ring shape towards the outer peripheral side along the radial direction. An upper end side of the shaft 26 is fixed to the top cover 2 by the fixing screw 6 that is screwed into the fixing screw hole 26b, and a lower end side of the shaft 26 is fixed to the base 4 by the support member 27.

A thickness of the disk-shaped part 28aa, along the axial direction may be smaller than a length of a part of the disk-shaped part 28aa opposing the first flange part 26c, along the radial direction.

The first flange part 26c is sandwiched between the cap 12 and the sleeve part 28a of the hub 28 along the axial direction. An upper surface of the first flange part 26c opposes a lower surface of the cap 12, and a lower surface of the first flange part 26c opposes an upper surface of the sleeve part 28a. The shaft 26 and the first flange part 26c in this embodiment are formed from a single member, however, the shaft 26 and the first flange part 26c may be formed from a plurality of separate members.

(Support Member)

The support member 27 is fixed to the base 4, and rotatably supports the hub 28 together with the shaft 26 that is fixedly supported by the support member 27. The support member 27 includes a cylindrical part 27a that surrounds the lower end of the shaft part 26a of the shaft 26, and a second flange part 27b that projects from an upper end part of the cylindrical part 27a in a ring shape towards the outer peripheral side along the radial direction.

The shaft part 26a, the first flange part 26c, and the second flange part 27b may form an example of a beam unit. The beam unit is sometimes referred to as a shaft body. On the other hand, the hub 28, including the sleeve part 28a, may form an example of a beam receiving unit. The beam receiving unit is sometimes referred to as a bearing body. The beam unit and the beam receiving unit may form the bearing mechanism in which the lubricant 92 is provided in a region including a gap between the beam unit and the beam receiving unit.

The cylindrical part 27a of the support member 27 is fixed to the base 4 by being press-fit, bonded, or the like into the center hole 4d that is located on the inner peripheral side of the projecting part 4c of the base 4 and has the rotational axis R as its center. The support member 27 is fixed to the base 4 together with the shaft 26 that is fixedly supported by the support member 27.

(Cap)

The cap 12 is formed by a ring-shaped member that is fixed to the hub 28. The cap 12 is provided so that the lower surface of the cap 12 opposes the upper surface of the first flange part 26c of the shaft 26 in the axial direction. The cap 12 fits into a ring-shaped stepped part 28f that is formed on the setting surface side (that is, the upper surface side in FIG. 2) of the hub 28 on which the recording disk 8 is set, and is fixed to the hub 28 by an adhesive, for example. The ring-shaped stepped part 28f forms a ring-shaped recess having the rotational axis R as its center.

The cap 12 may be formed by subjecting a steel material to cutting, pressing, or the like, for example. Alternatively, the cap 12 may be formed by molding a resin material, for example.

(Lubricant and Sealing Structure)

The lubricant 92 is provided in the gap between the hub 28 and the cap 12, the gap between the shaft 26 and the support member 27, and the communication passage 28e of the hub 28. The lubricant 92 includes a base oil that is added with a fluorescent material, and the lubricant 92 leaking from the gap between two members can easily be detected by irradiating light having a predetermined wavelength

A first gas-liquid interface 93 of the lubricant 92 is formed in a gap between the lower surface of the cap 12 and the upper surface of the first flange part 26c of the shaft 26. In addition, a first seal part 94 is formed by a tapered surface provided on the upper surface of the first flange part 26c of the shaft 26, and a gap formed by the first seal part 94 gradually increases from the outer peripheral edge of the first flange part 26c towards the rotational axis R along the radial direction. In other words, the gap of the first seal part 94 is provided in a tapered space extending towards the inner peripheral side along the radial direction. Because the force of the capillary action acts on the lubricant 92 towards the outer peripheral side in which the tapered space decreases, the lubricant 92 can be sealed between the cap 12 and the first flange part 26c of the shaft 26.

A second gas-liquid interface 95 of the lubricant 92 is formed in a gap between an outer peripheral surface of the second flange part 26b of the support member 27 and an inner peripheral surface of a cylindrical part 28g of the hub 28. The cylindrical part 28g of the hub 28 surrounds the second flange part 27b by projecting downwards from the outer peripheral part of the sleeve part 28a of the hub 28. In addition, a second seal part 96 is formed by a tapered surface provided on the outer peripheral surface of the second flange part 27b of the support member 27, and a gap formed by the second seal part 96 gradually increases downwards along the axial direction. Because the force of the capillary action acts on the lubricant 92 towards the upward direction in which the gap decreases, the lubricant 92 can be sealed between the second flange part 27b of the support member 27 and the cylindrical part 28g of the hub 28.

(Dynamic Pressure Generating Part)

A radial dynamic pressure generating part 81 is formed in a gap between the outer peripheral surface of the shaft part 26a of the shaft 26 and the inner peripheral surface of the sleeve part 28a of the hub 28, which oppose each other along the radial direction. A radial dynamic pressure generating groove 28h having a herringbone shape or a spiral shape, for example, is formed in the inner peripheral surface of the sleeve part 28a of the hub 28 at a part opposing the radial dynamic pressure generating part 81. When the hub 28 rotates, the radial dynamic pressure generating groove 28h generates a dynamic pressure in the lubricant 92 at the radial dynamic pressure generating part 81, in order to support the hub 28 in the radial direction. The radial dynamic pressure generating groove 28h may be formed in the outer peripheral surface of the shaft part 26a of the shaft 26.

The radial dynamic pressure generating part 81 is formed in the gap between the outer peripheral surface of the shaft part 26a of the shaft 26 and the inner peripheral surface of the sleeve part 28a of the hub 28, which oppose each other along the radial direction. A plurality of such dynamic pressure generating parts 81 may be provided along the axial direction. However, in this embodiment, a single dynamic pressure generating part that is continuous in the axial direction is formed as the dynamic pressure generating part 81 at one location in the gap between the outer peripheral surface of the shaft part 26a and the inner peripheral surface of the sleeve part 28a in order to improve the pumping efficiency. Although the radial dynamic pressure generating part 81 in this embodiment is provided approximately throughout the entire region along the axial direction in the gap in which the outer peripheral surface of the shaft part 26a of the shaft 26 and the inner peripheral surface of the sleeve part 28a of the hub 28 oppose each other along the radial direction, the radial dynamic pressure generating part 81 may be provided only in a part of the region along the axial direction in the gap.

A first thrust dynamic pressure generating part 82 is formed in a gap between the upper surface of the sleeve part 28a of the hub 28 and the lower surface of the first flange part 26c of the shaft 26. A first thrust dynamic pressure generating groove 28j having a herringbone shape or a spiral shape, for example, is formed in the upper surface of the sleeve part 28a of the hub 28 at a part opposing the first thrust dynamic pressure generating part 82. When the hub 28 rotates, the first thrust dynamic pressure generating groove 28j generates a dynamic pressure in the lubricant 92 at the first trust dynamic pressure generating part 82, in order to support the hub 28 in the axial direction. The first thrust dynamic pressure generating groove 28j may be formed in the lower surface of the first flange part 26c of the shaft 26.

A second thrust dynamic pressure generating part 83 is formed in a gap between the lower surface of the sleeve part 28a of the hub 28 and the upper surface of the second flange part 27b of the support member 27. A second thrust dynamic pressure generating groove 28k having a herringbone shape or a spiral shape, for example, is formed in the lower surface of the sleeve part 28a of the hub 28 at a part opposing the second thrust dynamic pressure generating part 83. When the hub 28 rotates, the second thrust dynamic pressure generating groove 28k generates a dynamic pressure in the lubricant 92 at the second trust dynamic pressure generating part 83, in order to support the hub 28 in the axial direction. The second thrust dynamic pressure generating groove 28k may be formed in the upper surface of the second flange part 27b of the support member 27.

According to the configuration described above, when the hub 28 rotates with respect to the support member 27, the dynamic pressure is generated in the lubricant 92 at each of the radial dynamic pressure generating part 81, the first thrust dynamic pressure generating part 82, and the second thrust dynamic pressure generating part 83. Hence, due to the dynamic pressure generated in the lubricant 92, the hub 28 rotates in a non-contact state in which the hub 28 is supported in the axial direction and in the radial direction and makes no contact with the shaft 26 and the support member 27.

The radial dynamic pressure generating groove 28h, the first thrust dynamic pressure generating groove 28j, and the second thrust dynamic pressure generating groove 28k can be formed by pressing, deformation or roll forming, electro-chemical machining, cutting that controls the position of a cutting tool using a piezoelectric element, or the like. However, the dynamic pressure generating grooves 28h, 28j, and 28k may be formed using mutually different methods, for example.

The first thrust dynamic pressure generating groove 28j and the second thrust dynamic pressure generating groove 28k are provided at positions separated from the shaft part 26a of the shaft 26 along the radial direction. Because the first thrust dynamic pressure generating groove 28j and the second thrust dynamic pressure generating groove 28k support the hub 28 at the positions separated from the shaft part 26a of the shaft 26, the hub 28 is unlikely to tilt even in a case in which external shock is applied to the rotating device 100, for example, and the rotation of the hub 28 stabilizes. Even in a case in which the thickness of the rotating device 100 is reduced and the radial dynamic pressure generating part 81 cannot be provided in a sufficiently large region that is sufficiently long in the axial direction, the above described Configuration can maintain the stable rotating state of the hub 28. In addition, the widths of the first thrust dynamic pressure generating groove 28j and the second thrust dynamic pressure generating groove 28k along the radial direction are preferably as small as possible within a range in which the desired dynamic pressure generating effect is obtainable in the lubricant 92, in order to reduce the power loss.

A more detailed description will be given on the configuration of the bearing mechanism, by referring to FIG. 3. FIG. 3 is a cross sectional view, on an enlarged scale, schematically illustrating the rotating device 100 in the first embodiment.

A thickness T along the axial direction of the rotating device 100 in the first embodiment is 5 mm. A length L of the radial dynamic pressure generating part 81 along the axial direction is 1 mm, and a gap Ds between the outer peripheral surface of the shaft part 26a of the shaft 26 and the sleeve part 28a of the hub 28 is 2 μm.

In addition, the first thrust dynamic pressure generating part 82 has an outer diameter Rt of 5.7 mm, a width Wt along the radial direction of 0.35 mm, and a gap Dt along the radial direction of 1.2 mm between the first thrust dynamic pressure generating part 82 and the shaft part 26a of the shaft 26. A gap Df along the axial direction between the lower surface of the first flange part 26c of the shaft 26 and the upper surface of the sleeve part 28a of the hub 28 in the first thrust dynamic pressure generating part 82 is 15 μm.

In this embodiment, the shaft 26, the hub 28, the radial dynamic pressure generating part 81, and the first thrust dynamic pressure generating part 82 are configured to satisfy the following relationship (1).

(Ds×2)/L>Df/Rt (1)

Because a ratio of the gap Df in the axial direction with respect to the outer diameter Rt of the first thrust dynamic pressure generating part 82 is smaller than a ratio of the gap Ds in the radial direction with respect to the length L along the axial direction of the radial dynamic pressure generating part 81, the rotational axis of the hub 28 is prevented from tilting, and the hub 28 can rotate more stably.

The dimensions of each of the parts of the rotating device 10 are not limited to the numerical values described above, and the dimensions may be appropriately set to satisfy the relationship (1) described above. According to the rotating device 100 in this first embodiment, stable rotation of the hub 28 can be maintained even in the case of the configuration in which the thickness T along the axial direction of the rotating device 100 is reduced. As a result, the data read and/or write error of the recording disk 8 can be prevented.

### Second Embodiment

Next, a description will be given of a second embodiment. Illustration and description of those constituent elements of the second embodiment that are the same as those of the first embodiment described above will be omitted.

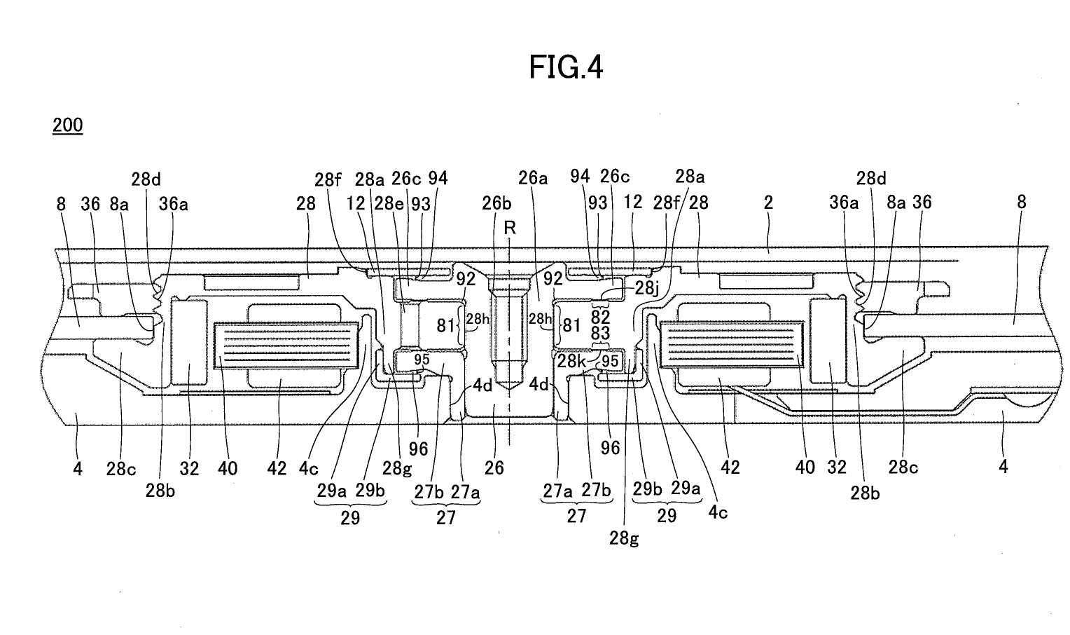

FIG. 4 is a cross sectional view schematically illustrating an example of a rotating device 200 in the second embodiment. The rotating device 200 in this second embodiment includes a ring-shaped member 29, and a sealing structure to seal the lubricant 92 is different from that of the rotating device 100 in the first embodiment.

As illustrated in FIG. 4, the rotating device 200 includes the ring-shaped member 29 that has a semi-cylindrical shape and is provided on the outer side of the cylindrical part 28g of the hub 28 surrounding the second flange part 27b of the support member 27.

The ring-shaped member 29 includes a cylindrical surrounding part 29a, and a toroidal part 29b having a hollow disk shape. The surrounding part 29a surrounds the cylindrical part 28g of the hub 28, and is fitted on the outer peripheral surface of the cylindrical part 28g of the hub 28 and fixed by an adhesive or the like, for example. The toroidal part 29b projects from the lower end of the surrounding part 29a towards the inner peripheral side, and covers the outer peripheral side of the lower surface of the second flange part 27b of the support member 27.

A second gas-liquid interface 95 of the lubricant 92 is formed in a gap between an upper surface of the toroidal part 29b of the ring-shaped member 29 and the lower surface of the second flange part 27b of the support member 27. A second seal part 96 is formed by a tapered surface provided on the lower surface of the second flange part 27b of the support member 27, and a gap formed by the second seal part 96 gradually increases from the outer peripheral edge of the second flange part 27b towards the rotational axis R along the radial direction. Because the force of the capillary action acts on the lubricant 92 towards the outer peripheral side in which the gap decreases, the lubricant 92 can be sealed between the second flange part 27b of the support member 27 and the toroidal part 29b of the ring-shaped member 29.

In addition, because the space from the second gas-liquid interface 95 and reaching the recording disk 8 can be made long between the ring-shaped member 29 and the base 4 and also complex in shape, it is possible to suppress adhesion of the lubricant 92 scattering from the second gas-liquid interface 95 onto the recording disk 8.

A thickness along the axial direction of the rotating device 200 in the second embodiment is 5 mm. Further, in the rotating device 200 in this second embodiment, a length L of the radial dynamic pressure generating part 81 along the axial direction, a gap Ds between the outer peripheral surface of the shaft part 26a of the shaft 26 and the sleeve part 28a of the hub 28, an outer diameter Rt of the first thrust dynamic pressure generating part 82, and a gap Df along the axial direction between the lower surface of the first flange part 26c of the shaft 26 and the upper surface of the sleeve part 28a of the hub 28 in the first thrust dynamic pressure generating part 82 are the same as those of the rotating device 100 in the first embodiment, and satisfy the relationship (1) described above.

In addition, in the example of the configuration employed in this second embodiment, the second seal part 96 requiring a certain length is provided to extend in the radial direction, in order to enable further reduction in the thickness of the rotating device 200 in the axial direction. In other words, the second seal part 96 is provided in the tapered space in which the gap extends inwards in the radial direction.

In addition, according to the rotating device 200 in the second embodiment, the first seal part 94, the first thrust dynamic pressure generating part 82, the second thrust dynamic pressure generating part 83, and the second seal part 96 are provided in a stacked arrangement along the axial direction. In other words, the first thrust dynamic pressure generating part 82 and the second thrust dynamic pressure generating part 83 are sandwiched between the first seal part 94 and the second seal part 96 along the axial direction.

The tablet PCs presently being developed may have a thickness dimension on the order of 7.5 mm or less. On the other hand, when providing the HDD in the tablet PC, an LCD (Liquid Crystal Display), a circuit board for supplying signals to the LCD, and a bottom lid may be stacked along the thickness direction together with the HDD. In a case in which the LCD has a thickness of 1.2 mm, the circuit board has a thickness of 1.2 mm, the bottom lid has a thickness of 0.7 mm, and a total of gaps between the stacked members is 0.4 mm, for example, the thickness of the tablet PC becomes 7.5 mm or less when the HDD has a thickness of 4.0 mm or less and 2.0 mm or greater, for example. In other words, when the HDD has the thickness of 4.0 mm or less, the thickness of the tablet PC can be 7.5 mm or less, and the tablet PC can be improved from the viewpoint of design, operating (or manipulating) ease, and commercial value of the product. Moreover, according to simulations conducted by the present inventor, it was confirmed that the bearing mechanism can withstand external shock caused by drop impact when the HDD formed by a rotating device with a configuration similar to that of the rotating device 200 and the HDD has a thickness of 2.0 mm or greater.

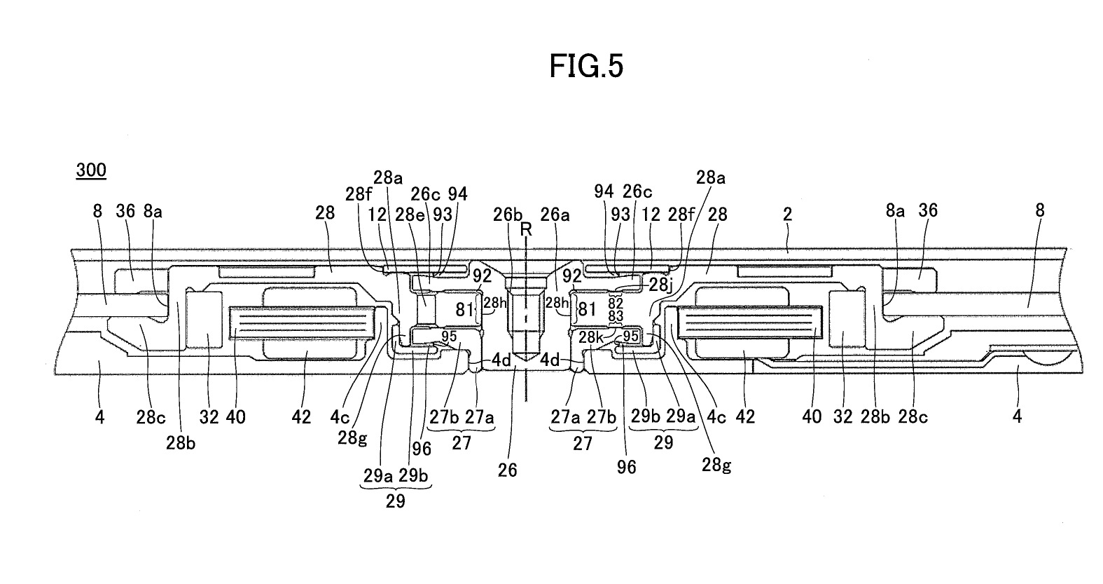

FIG. 5 is a cross sectional view schematically illustrating another example of a rotating device 300 in the second embodiment, having a configuration similar to that of the rotating device 200 illustrated in FIG. 4.

As illustrated in FIG. 5, each part of the rotating device 300, such as the top cover 2, the base 4, the hub 28, and the shaft 26, are made thin along the axial direction, so that the total thickness of the rotating device 300 along the axial direction can be reduced. In addition, the total thickness of the rotating device 300 along the axial direction can further be reduced, by making each part of the rotating device 300 as thin as possible within a range in which the desired accuracy of dimension and the desired accuracy of finishing can be maintained.

As described above, according to the rotating devices 200 and 300 in the second embodiment, the stable rotation of the hub 28 can be maintained, even when the configuration is thinned in a manner similar to that of the rotating device 100 in the first embodiment. In addition, the adhesion of the lubricant 92 scattering from the gas-liquid interface onto the recording disk 8 can be suppressed. Hence, the generation of the data read and/or write error of the recording disk 8, caused by unstable rotation of the recording disk 8 and/or adhesion of the lubricant 92 onto the recording disk 8, can further be reduced.

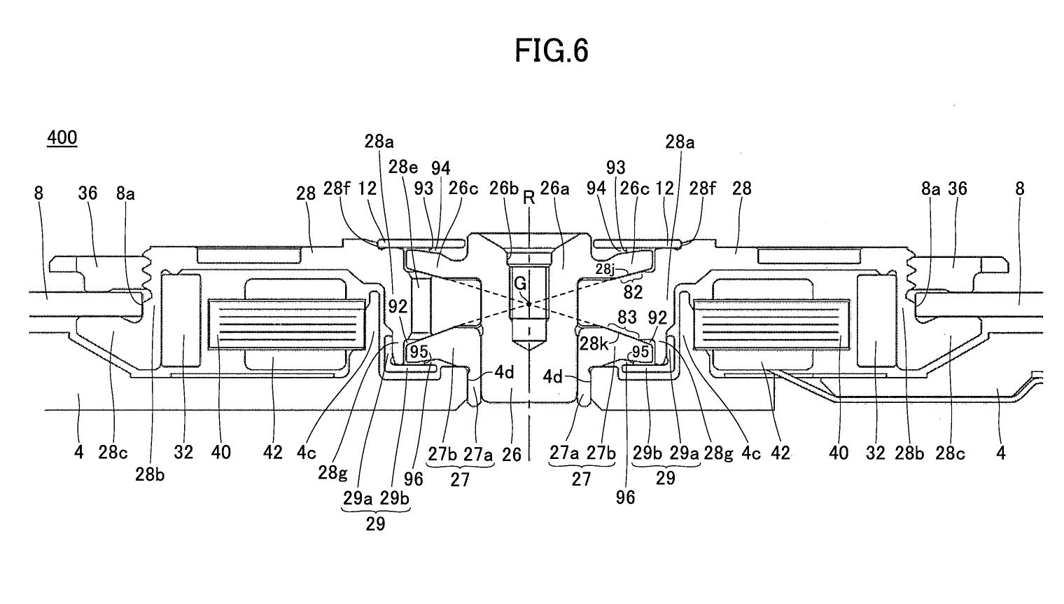

The first thrust dynamic pressure generating part 82 and the second thrust dynamic pressure generating part 83 may be formed to be inclined with respect to a plane perpendicular to the axial direction. FIG. 6 is a cross sectional view schematically illustrating still another example of a rotating device 400 in the second embodiment, in which the first thrust dynamic pressure generating part 82 and the second thrust dynamic pressure generating part 83 are inclined. Inclination angles of the first thrust dynamic pressure generating part 82 and the second thrust dynamic pressure generating part 83 may be set to arbitrary angles, respectively.

In the rotating device 400 illustrated in FIG. 6, the first thrust dynamic pressure generating part 82 and the second thrust dynamic pressure generating part 83 are inclined by the same inclination angle with respect to the plane perpendicular to the axial direction, but in opposite sloping directions, respectively. In addition, an extension of the first thrust dynamic pressure generating part 82 and an extension of the second thrust dynamic pressure generating part 83 intersect at a center of gravity, G, of the hub 28 that extends along the rotational axis R in a state in which the recording disk 8 is set on the hub 28.

According to the rotating device 400 in this second embodiment, the rotational axis of the hub 28 is prevented from tilting due to effects of external shock, vibration, or the like, even in a case in which the external shock, vibration, or the like is applied to the rotating device 400 in directions other than the axial direction or the radial direction. For this reason, according to the rotating device 400, it is possible to more stably maintain rotation of the hub 28 that is set with the recording disk 8.

In each of the embodiments described above, the rotating device is a shaft fixed type in which the shaft 26 is fixed to the base 4. However, the configuration of the rotating device is not limited to the shaft fixed type, and the rotating device may be a shaft rotating type in which the shaft 26 is rotatable supported together with the hub 28 on which the recording disk 8 is set.

According to each of the embodiments, it is possible to provide a rotating device that can maintain stable rotation of a rotor part in a thinned configuration.

Although the embodiments are numbered with, for example, “first,” or “second,” the ordinal numbers do not imply priorities of the embodiments.

Although the embodiments of the present invention have been described in detail, it should be understood that the various changes, substitutions, and alterations could be made hereto without departing from the spirit and scope of the invention.

What is claimed is:

1. A rotating device comprising:
a beam unit that includes a shaft part, a first flange part projecting in a ring shape from one end of the shaft part in a radial direction perpendicular to an axial direction, and a second flange part projecting in a ring shape in the radial direction from another end of the shaft part;
a beam receiving unit that includes a sleeve part surrounding the shaft part in a state in which the sleeve part is rotatable relative to the shaft part, wherein a lubricant is provided in a region that includes a first gap between the beam unit and the beam receiving unit;
a single radial dynamic pressure generating groove provided at one of mutually opposing surfaces of the shaft part and the sleeve part, opposing each other in the radial direction;
a first thrust dynamic pressure generating groove provided at one of mutually opposing surfaces of the first flange part and the sleeve part, opposing each other in the axial direction; and
a second thrust dynamic pressure generating groove provided at one of mutually opposing surfaces of the second flange part and the sleeve part, opposing each other in the axial direction,
wherein the first thrust dynamic pressure generating groove and the second thrust dynamic pressure generating groove are separated from the shaft part along the radial direction.

2. The rotating device as claimed in claim 1, wherein the beam receiving unit includes a setting part on which a recording disk is set, and a center of gravity of the beam receiving unit in a state in which the recording disk is set on the setting part is located at a position within a range of the single radial dynamic pressure generating groove.

3. The rotating device as claimed in claim 1, wherein a relationship (Ds×2)/L>Df/Rt is satisfied, where L denotes a length of the single radial dynamic pressure generating groove along the axial direction, Ds denotes a second gap where the beam unit and the sleeve part oppose each other in the radial direction, Rt denotes an outer diameter of the first thrust dynamic pressure generating groove, and Df denotes a third gap where the first flange part and the sleeve part oppose each other in the axial direction.

4. The rotating device as claimed in claim 1, wherein widths along the radial direction of the first thrust dynamic pressure generating groove and the second thrust dynamic pressure generating groove are smaller than a width along the axial direction of the single radial dynamic pressure generating groove.

5. The rotating device as claimed in claim 1,
wherein the beam receiving unit includes a ring-shaped cap covering a surface of the first flange part on an opposite side from the sleeve part, and
the rotating device further comprises:
a seal part, provided in a gap between the first flange part and the cap, and configured to seal the lubricant.

6. The rotating device as claimed in claim 1,
wherein the beam receiving unit includes a cylindrical part surrounding the second flange, and
the rotating device further comprises:
a seal part, provided in a gap between the second flange part and the cylindrical part, and configured to seal the lubricant.

7. The rotating device as claimed in claim 1,
wherein the beam receiving unit includes a ring-shaped member covering a surface of the second flange part on an opposite side from the sleeve part, and
the rotating device further comprises:
a seal part, provided in a gap between the second flange part and the ring-shaped member, and configured to seal the lubricant.

8. The rotating device as claimed in claim 1, wherein a dimension of the rotating device along the axial direction, at a center axis of the shaft part, is 4.0 mm or less.

9. A rotating device comprising:
a beam unit that includes a shaft part, a first flange part projecting in a ring shape from one end of the shaft part in a radial direction perpendicular to an axial direction, and a second flange part projecting in a ring shape in the radial direction from another end of the shaft part;
a beam receiving unit that includes a sleeve part surrounding the shaft part in a state in which the sleeve part is rotatable relative to the shaft part, wherein a lubricant is provided in a region that includes a first gap between the beam unit and the beam receiving unit;
a single radial dynamic pressure generating groove provided at one of mutually opposing surfaces of the shaft part and the sleeve part, opposing each other in the radial direction;
a first thrust dynamic pressure generating groove provided at one of mutually opposing surfaces of the first flange part and the sleeve part, opposing each other in the axial direction; and
a second thrust dynamic pressure generating groove provided at one of mutually opposing surfaces of the second flange part and the sleeve part, opposing each other in the axial direction,
wherein the first thrust dynamic pressure generating groove and the second thrust dynamic pressure generating groove are separated from the shaft part along the radial direction, and
wherein widths along the radial direction of the first thrust dynamic pressure generating groove and the second thrust dynamic pressure generating groove are smaller than a width along the axial direction of the single radial dynamic pressure generating groove.

10. The rotating device as claimed in claim 9, wherein the beam receiving unit includes a setting part on which a recording disk is set, and a center of gravity of the beam receiving unit in a state in which the recording disk is set on the setting part is located at a position within a range of the single radial dynamic pressure generating groove.

11. The rotating device as claimed in claim 9, wherein a relationship (Ds×2)/L>Df/Rt is satisfied, where L denotes a length of the single radial dynamic pressure generating groove along the axial direction, Ds denotes a second gap where the beam unit and the sleeve part oppose each other in the radial direction, Rt denotes an outer diameter of the first thrust dynamic pressure generating part, and Df denotes a third gap where the first flange part and the sleeve part oppose each other in the axial direction.

12. The rotating device as claimed in claim 9,
wherein the beam receiving unit includes a ring-shaped cap covering a surface of the first flange part on an opposite side from the sleeve part, and
the rotating device further comprises:
a seal part, provided in a gap between the first flange part and the cap, and configured to seal the lubricant.

13. The rotating device as claimed in claim 9,
wherein the beam receiving unit includes a cylindrical part surrounding the second flange, and
the rotating device further comprises:
a seal part, provided in a gap between the second flange part and the cylindrical part, and configured to seal the lubricant.

14. The rotating device as claimed in claim 9,
wherein the beam receiving unit includes a ring-shaped member covering a surface of the second flange part on an opposite side from the sleeve part, and
the rotating device further comprises:
a seal part, provided in a gap between the second flange part and the ring-shaped member, and configured to seal the lubricant.

15. The rotating device as claimed in claim 9, wherein a dimension of the rotating device along the axial direction, at a center axis of the shaft part, is 4.0 mm or less.

16. A rotating device comprising:
a beam unit that includes a shaft part, a first flange part projecting in a ring shape from one end of the shaft part in a radial direction perpendicular to an axial direction, and a second flange part projecting in a ring shape in the radial direction from another end of the shaft part;
a beam receiving unit that includes a disk-shaped part surrounding the shaft part in a state in which the disk-shaped part is rotatable relative to the shaft part, wherein a lubricant is provided in a region that includes a first gap between the beam unit and the beam receiving unit;
a radial dynamic pressure generating groove provided at one of mutually opposing surfaces of the beam unit and the disk-shaped part, opposing each other in the radial direction;
a first thrust dynamic pressure generating groove provided at one of mutually opposing surfaces of the first flange part and the disk-shaped part, opposing each other in the axial direction; and
a second thrust dynamic pressure generating groove provided at one of mutually opposing surfaces of the second flange part and the disk-shaped part, opposing each other in the axial direction,
wherein a dimension of the rotating device along the axial direction, at a center axis of the shaft part, is 4.0 mm or less, and
wherein a thickness of the disk-shaped part along the axial direction is smaller than a length of a part of the disk-shaped part opposing the first flange part, along the radial direction.

17. The rotating device as claimed in claim 16, wherein the first thrust dynamic pressure generating groove and the second thrust dynamic pressure generating groove are separated from the shaft part along the radial direction.

18. The rotating device as claimed in claim 16,
wherein the beam receiving unit includes a ring-shaped cap covering a surface of the first flange part on an opposite side from the disk-shaped part, and
the rotating device further comprises:
a seal part, provided in a gap between the first flange part and the cap, and configured to seal the lubricant.

19. The rotating device as claimed in claim 16,
wherein the beam receiving unit includes a cylindrical part surrounding the second flange, and
the rotating device further comprises:
a seal part, provided in a gap between the second flange part and the cylindrical part, and configured to seal the lubricant.

20. The rotating device as claimed in claim 16,
wherein the beam receiving unit includes a ring-shaped member covering a surface of the second flange part on an opposite side from the disk-shaped part, and
the rotating device further comprises:
a seal part, provided in a gap between the second flange part and the ring-shaped member, and configured to seal the lubricant.
